(19) United States
(12) Patent Application Publication
(10) Pub. No.: US 2003/0208601 A1
(43) Pub. Date: Nov. 6, 2003

(54) System and method for session control in a mobile internet protocol network

(76) Inventors: Edward P. Campbell, Libertyville, IL (US); Michael S. Borella, Naperville, IL (US)

Correspondence Address: McDonnell Boehnen Hulbert & Berghoff, 32nd Floor, 300 S. Wacker Drive, Chicago, IL, 60606, US

(21) Appl. No.: 09/998,819

(22) Filed: Oct. 25, 2001

(51) Int. Cl. G06F 15/16

(52) U.S. Cl. 709/227

(57) ABSTRACT

Systems and methods are shown for packet session control in a mobile communication network. One method involves conducting a first communication session on a mobile node, detecting a second communication session to be connected to the mobile node, and, responsively, determining whether the second session is accepted and the first communication session is suspended. If the first communication session is suspended, the method further involves intercepting data flow associated with the first communication session, and switching data flow associated with the second communication session to an existing air interface associated with the first communication session. In one embodiment, the air interface includes a plurality of communication channels, and the method involves switching data flow associated with the second communication session to a communication channel associated with the first communication session. In another embodiment, the method involves terminating the communication channel associated with the first communication session and setting up a second communication channel over the existing air interface to communicate data associated with the second communication session.

### FIELD OF THE INVENTION

The present invention relates to communications in mobile Internet Protocol (“IP”) networks. More particularly, it relates to a packet session control mechanism in such networks.

### BACKGROUND OF THE INVENTION

With the rapidly growing interest in wireless communications and Internet connectivity, wireless service providers are competing to capture the market share by offering their customers access to applications that take advantage of both technologies. However, as service providers attempt to widen their customer base, they are discovering inherent difficulties of providing combined voice and data services within circuit-switched networks. These infrastructures cannot meet the enormous demand for bandwidth or support timely, cost-effective delivery of emerging services and applications.

In a mobile Internet Protocol network, a mobile communication device (a mobile node), such as a mobile host or router that changes its point of attachment from one network to another, communicates with a target host on an Internet Protocol (“IP”) network by means of two devices, a “foreign agent” and a “home agent.” Typically, the foreign agent's functionality is incorporated into a router on a mobile node's visited network. The foreign agent provides routing services for the mobile node while it is registered with the home agent. For example, the foreign agent de-tunnels and delivers data packets that were tunneled by the mobile node's home agent to the mobile node.

A home agent is typically incorporated into a router on a mobile node's home network. The home agent maintains current location information for the mobile node. When one or more home agents are handling calls for multiple mobile nodes simultaneously, the home agents are providing, in essence, a service analogous to a virtual private network service.

Mobile Internet Protocol requires the link layer connectivity between a mobile node (a mobile entity) and a foreign agent. However, in some systems the link layer from the mobile node may terminate at a point distant from the foreign agent. Such networks are commonly referred to as third-generation (3G) wireless networks. A 3G network delivers much greater network capacity than many currently existing circuit-switched digital mobile networks. The increased availability of bandwidth in 3G networks opens up a new generation of applications to wireless subscribers such as collaborative and multimedia services. By implementing 3G networks, subscribers are able to use a single device to access their wireless network services from any location around the globe, which simplifies the use of networks and broadens their utility. In addition, 3G network standards take into account the ubiquity of the Internet Protocol that allows users of Internet Protocol landline networks to gain seamless connectivity to corporate intranets and public Internet services.

FIG. 1 is a block diagram illustrating a network architecture 100 that is typically employed in 3G wireless networks. Referring to FIG. 1, a mobile node 102 communicates with a target host 116 on an Internet Protocol network 112 by means of three devices, a radio network node 106, a packet data serving node (“PDSN”) 108 and a home agent node 114. The mobile node 102 is coupled to the radio network node 106 via a base station 104. The physical layer of the mobile node 102 terminates on the radio network node 106, and the foreign agent's functionality resides on the packet data serving node 108. For example, the mobile node may be linked to the radio network node 106 via a communication link on a radio access network. The packet data serving node 108 bridges a radio network to the IP network 112 via a serving router. Primarily, the packet data serving node 108 establishes, maintains and terminates link layer sessions to mobile clients such as the mobile node 102. Some of the functions that may be performed on the packet data serving node 108 may include, but are not limited to, IP address assignment for simple IP services and performing foreign agent's functionality for visiting mobile nodes. The simple IP-based services may include supporting a mobile node's initiated dial-in, for instance. Further, the packet data serving node 108 is a 3G-system interface between an access network and a data network. It terminates the data link layer from the mobile node 102 and routes upper layer protocols into a data network directly. For mobile IP based services, the packet data serving node 108 supports the standard mobile IP foreign agent's functionality with extensions to support reverse tunneling, foreign agent challenge/response authentication, network access identifier (“NAI”) based registration, and dynamic home agent and home address assignment.

The home agent 114 is configured to accept registration requests from network entities such as home agent control nodes, and, further, creates a mobility binding record and an IP tunnel to terminate tunneled IP traffic from the packet data serving node 108. A home agent control node may be configured to accept all mobile IP registration messages from mobile nodes via the packet data serving node 108. Then, the home agent control node may forward the messages to a designated home agent. The home agent 114 decapsulates and routes data traffic in the reverse direction to Internet Service Providers (“ISPs”). The home agent 114 also receives data traffic from the Internet Service Providers, encapsulates, and tunnels it in the forward direction to the packet data serving node 108.

Further, as illustrated in FIG. 1, the network architecture 100 includes an Authentication, Authorization and Accounting (“AAA”) server 110, such as a Remote Authentication Dial-In User Service (“RADIUS”) server. As is known in the art, RADIUS enables remote access servers to communicate with a central server, to authenticate users and to authorize their access to the requested system or service. The AAA server 110 may reside on a visited or foreign network as well as on a home network. The packet data serving node 108 may use the AAA server 110 to perform authentication during point-to-point protocol (“PPP”) sessions with the mobile node 102. The packet data serving node 108 may also interact with the AAA server 110 during a mobile IP registration process. The AAA server 110 may further relay requests to an appropriate home AAA server.

As the wireless industry moves toward convergence of voice and data applications, 3G wireless networks provide not only higher bandwidth, but also means for deploying emerging services and applications across networks. With growing popularity of multimedia applications including, for example, text, sound, graphic, and video applications, or a combination thereof, mobile terminal users may be simultaneously involved in a number of communication sessions. Normally, if two or more communication sessions terminate on a mobile node, one or more of the sessions is suspended (put “on hold”), while only one session is actively used on the mobile node. In the current systems, however, such an embodiment results in the waste of airlink bandwidth (bandwidth between a radio node and a mobile node), since two or more air link interfaces are being used to and from the mobile node, even though only one session is actively used on the mobile node and the other sessions are put “on hold.”

Therefore, a need exists for a method and system of saving airlink bandwidth in 3G networks.

### SUMMARY OF THE INVENTION

The system and methods are illustrated for controlling a plurality of communication sessions on a mobile node in a mobile network.

An embodiment of a method for controlling a plurality of communication sessions in a mobile network involves establishing a first communication session at a mobile node, detecting a second communication session to be connected to the mobile node, determining whether the second communication session is accepted on the mobile node and whether the first communication session is put on hold on the mobile node to enable communicating data associated with the second communication session. If the first communication session is put on hold, the method further involves intercepting a data flow associated with the first communication session and switching a data flow associated with the second communication session to an existing air interface associated with the first communication session. In one embodiment, the air interface includes a plurality of communication channels, and the step of switching the second communication session to the existing air interface involves terminating the data flow on an existing communication channel associated with the first communication session, and employing the existing communication channel for data communication associated with the second communication session. In an alternative embodiment, the method may involve terminating the existing communication channel associated with the first communication session and setting up a new communication channel over the same air interface to facilitate communicating of data associated with the second communication session.

These as well as other aspects and advantages of the present invention will become more apparent to those of ordinary skill in the art by reading the following detailed description, with reference to the accompanying drawings.

### BRIEF DESCRIPTION OF THE DRAWINGS

Exemplary embodiments of the present invention are described with reference to the following drawings, in which:

FIG. 1 is a block diagram illustrating an example of a prior art mobile IP network architecture;

FIG. 2 is a block diagram illustrating an example of a mobile IP network architecture according to one exemplary embodiment of the present invention;

FIG. 3 is a flow chart illustrating a method for controlling a plurality of communication sessions on a packet session control device according to one exemplary embodiment; and

FIGS. 4A and 4B are a flow chart illustrating a method for controlling a plurality of communication sessions on a mobile node according to one exemplary embodiment.

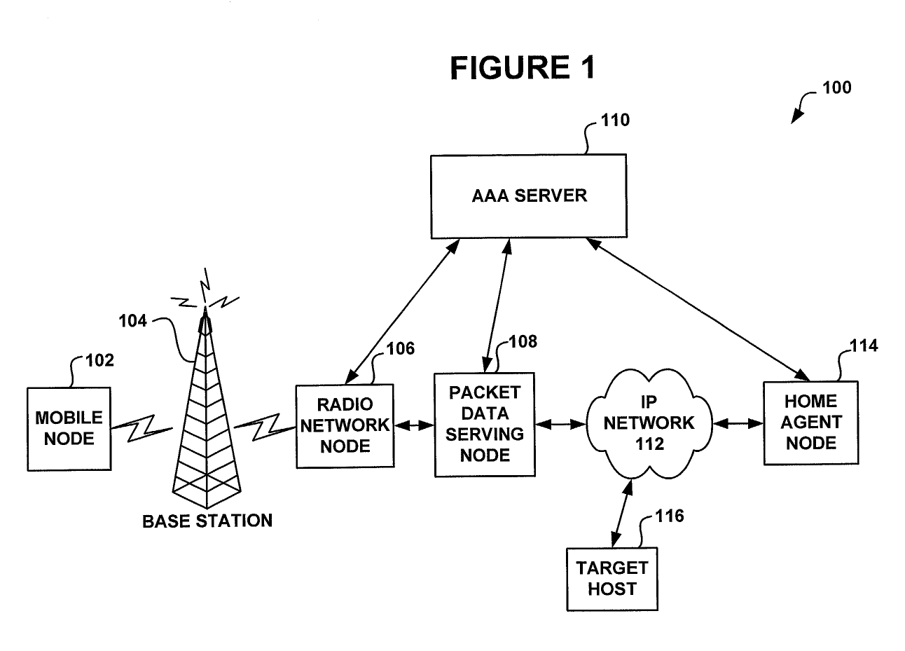

### DETAILED DESCRIPTION OF PREFERRED EMBODIMENT(S)

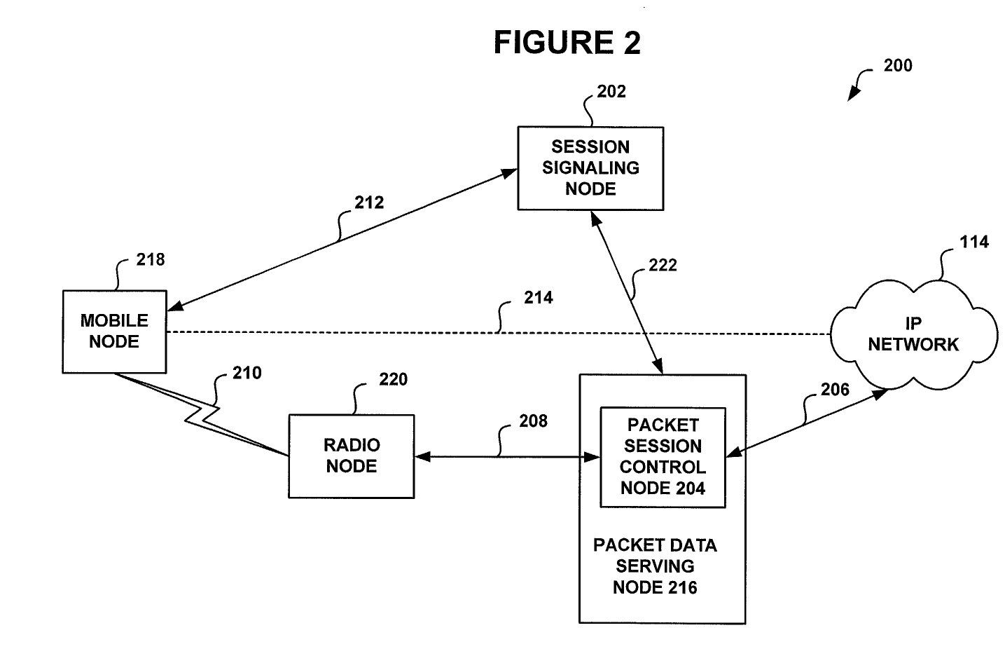

FIG. 2 is a functional block diagram illustrating an exemplary embodiment of a network architecture 200 suitable for application to the present invention for packet session control in 3G wireless networks. FIG. 2 shows the network architecture 200 including a mobile node (“MN”) 218 linked to a radio network including a radio node (“RN”) 220 via a communication link 210. The MN 218 may include a client device such as a cellular telephone, a computer, a fax machine or a personal digital assistant (“PDA”). In one embodiment, the MN 218 may include a Code Division Multiple Access (“CDMA”) capable client device, such as a CDMA telephone. In an alternative embodiment, the MN 218 may include a CDMA capable router. In such an embodiment, the CDMA router may be configured to provide network services to a number of client devices such as mobile or fixed-location client devices, for example.

The communication link 210 may include an air interface via one or more base stations. In mobile communication networks, an air interface may be described as having a four-layer protocol stack, which ensures compatibility between mobile terminals and a base station. In terms of the Open System Interconnection (“OSI”) reference model, the layers include a physical layer, a media access control (“MAC”) layer, a data link control layer, and a network layer. The physical layer specifies radio characteristics such as channel frequencies, modulation schemes, power and power sensitivity levels, and data framing. The MAC layer specifies procedures by which the mobile terminal and the base station negotiate selection of a communication channel to be employed for communicating data to and from the mobile terminal. The data link control layer specifies the manner in which the frames are sequenced, and the mechanisms that are used to ensure their integrity during transmission. The network layer specifies mechanisms used to identify and authenticate the mobile terminal to the base station.

According to an exemplary embodiment, the MN 218 employs a communication channel enabling bi-directional communications to and from the MN 218. A communication channel is a physical channel used for communication of information between the MN 218 and the base station. Referring back to FIG. 2, the radio network includes the RN 220 that is linked to a packet session control node (“PSCN”) 204 via a communication link 208. As illustrated in FIG. 2, the PSCN 204 is located in a packet data serving node (“PDSN”) 216. However, it should be understood that the PSCN 204 may be a standalone entity having one or more communication links with the PDSN 216. According to an exemplary embodiment that will be described in greater detail below, the PSCN 204 is configured to terminate the use of the air interface for any data stream that is associated with a suspended session (a session put “on hold”) on the MN 218, thus, sending only one data stream to the MN 218 at any given time. According to one exemplary embodiment, a communication session refers to a continuous use of a service such as, for example, a packet data, VoIP, or multimedia transmission service, by a user associated with the MN 218 over a communication channel. In one embodiment, the communication session starts when the service is invoked and ends when the service is terminated. For example, the service may be initiated and terminated by a user or a network. A session on the MN 218 can be defined as a Real-Time Transfer Protocol (“RTP”) session between the IP network 114 and the mobile node 218. The RTP session is a virtual connection and is illustrated in FIG. 2 as a dashed connection 214. An RTP session may be established using, for example, a Session Initiation Protocol (“SIP”) or any H.323-based protocol.

The PSCN 204 is further linked to the IP network 114 via a communication link 206 and further to a session signaling node 202 via a communication link 222. In one embodiment, the session signaling node 202 may be a Session Initiation Protocol (“SIP”) proxy server. As is known in the art, the Session Initiation Protocol is an application layer control protocol, defined in Request For Comments (“RFC”) 2543, herein incorporated by reference and available from the Internet Engineering Task Force (IETF). The session signaling node 202 is used to establish, maintain and terminate calls between two or more end points such as the MN 218 and one or more network entities. Further, the session signaling node 202 incorporates the functions of signaling and session management. The signaling functionality provides call information to network entities in the network architecture 200. The session management functionality provides the ability to control an end-to-end session. Additionally, the session signaling node 202 may provide functions such as, for example, authentication, authorization, network access control, or reliable request retransmission and security. As illustrated in FIG. 2, the MN 218 communicates with the session signaling node 202 via a communication link 212. FIG. 2 illustrates a direct communication link 212 between the MN 218 and the session signaling node 202. However, it should be understood that the communication link 212 is a virtual connection, and communications to and from the MN 218 is carried out via the radio network and/or the PDSN 216.

According to an exemplary embodiment, the MN 218 includes a user interface that is implemented to allow a user of the MN 218 to switch between communication sessions or to terminate a communication session using, for example, SIP signaling message between the MN 218 and the PDSN 216. In one embodiment, the user interface may allow a user to configure a number of indicators such as audible tones or text messages, for example, for different data types. In such an embodiment, when a new incoming session is detected, i.e., the MN 218 receives a signaling message indicating a new session, the MN 218 may notify the user of a type of the incoming session using a predetermined identifier, such as, for example, a predetermined audible tone, thus, enabling the user to decide whether to accept or reject the incoming session based on the type of data associated with the incoming session. In an alternative embodiment, the user may accept or reject the incoming session based on the actual data such as a caller ID data.

FIG. 2 illustrates the exemplary architecture 200 suitable for application of the present invention; however, it should be understood that more, fewer, different or equivalent network devices could also be used. Further, those skilled in the art will appreciate that the functional entities illustrated in FIG. 2 may be implemented as discrete components or in conjunction with other components, in any suitable combination and configuration. For example, the packet control node 204 is not limited to being implemented on or in communication with packet data serving nodes. In an alternative embodiment, the packet control node 204 may be implemented on a Global System for Mobile Communication (“GSM”) entity. GSM uses a circuit-switched architecture, and provides voice, mail, data, fax and paging capabilities. In a GSM system, the packet control node 204 is implemented on a Gateway General Packet Radio Service (“GPRS”) Support Node (“GGSN”), for instance. As is known in the art, GPRS is a system that bridges packet-switching to existing GSM networks and is often considered a 2.5G technology since it allows operators to bridge the existing networks with the 3G networks. Further, as is known in the art, GGSN connects the GPRS network to external packet-based networks such as the Internet or corporate Intranets. Different embodiments are possible as well.

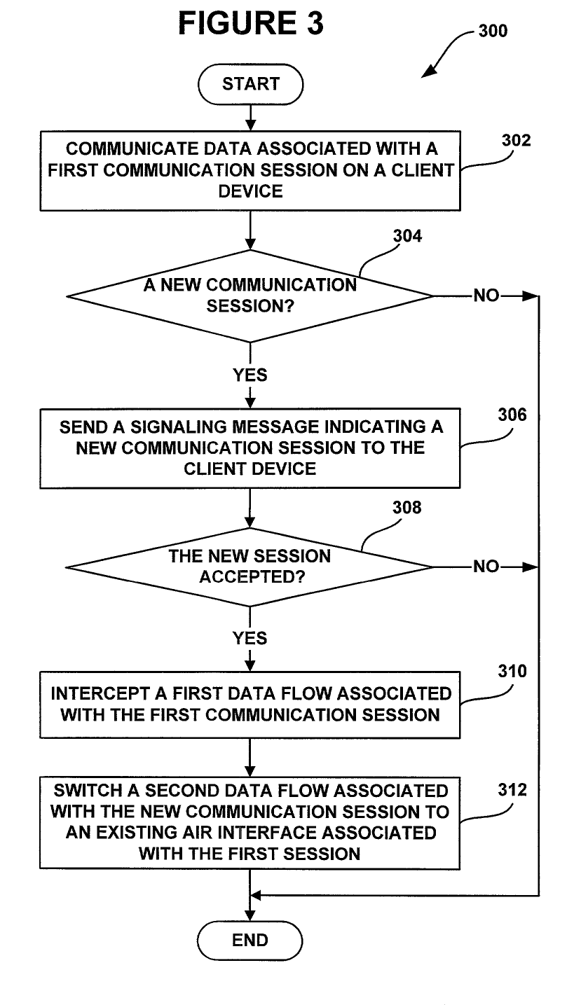

FIG. 3 is a flow chart illustrating a method 300 for controlling a plurality of communication sessions on a packet session control device according to one embodiment of the present invention. At step 302, a first network device communicates data associated with a first communication session on a client device. According to the exemplary embodiment illustrated in FIG. 2, the first network device may include the PDSN 216 and the client device may include the MN 218. Alternatively, the first network device may include a GGSN, or any other currently existing or later develop serving nodes. Further, for example, the first communication session may include a Voice Over Internet Protocol (“VoIP”) session, a web browsing session, a packet data session, a facsimile over IP session or an IP multimedia session. The first communication session may be further associated with an RTP session, such as the session 214, from the MN 218 to the IP network 114 illustrated in FIG. 2.

At step 304, the first network device determines whether a remote client device has initiated establishing a second communication session to the client device. According to an exemplary embodiment, a second network device may notify the first network device about the second incoming communication session. In the embodiment illustrated in FIG. 2, the second network device may include the session signaling node 202, such as a SIP proxy server, that sends a new incoming session notification message to the PDSN 216. For instance, the notification message may be a SIP INVITE message indicating the second incoming communication session to be connected to the MN 218.

At step 306, the first network device sends to the client device a signaling message indicating the new incoming communication session. According to an exemplary embodiment described in the preceding paragraph, the PDSN 216 may forward to the client device the SIP INVITE message received from the session signaling node 202.

At step 308, the first network device determines whether the new communication session is accepted on the client device. In one embodiment, the client device may notify the first network device that the new communication session is accepted by sending a SIP NOTIFY message or a SIP INFO message to the second network device. The SIP NOTIFY message or the SIP INFO message may include a request to put the first session on hold and accept the new communication session. Alternatively, the SIP NOTIFY message or the SIP INFO message may include a request to terminate the first session and accept the new session. The second network device may then employ a policy service protocol to notify the first network device regarding the acceptance of the new communication session on the client device. In one embodiment, the second network device may employ any existing or later developed protocols, such as, for example, a Common Open Policy Service (“COPS”) Protocol. More information on COPS may be found in the RFC 2748, herein incorporated by reference and available from the IETF.

At step 310, the first network device intercepts a first data flow associated with the first communication session. At step 312, the first network device switches a second data flow associated the new incoming communication session to an existing air interface that was employed for communicating data associated with the first communication session. The air interface may include a plurality of communication channels that may be employed for communicating data to and from the client device. In one embodiment, to communicate data associated with the new incoming communication session, the first network device may employ a communication channel that was used for communicating data associated with the first communication session. In such an embodiment, the PDSN 216 or GGSN may, for example, terminate the first SIP session and switch the new SIP session to the existing communication channel.

In an alternative embodiment, the first network device may terminate a communication channel that was used for communicating data associated with the first communication session and then may set up a second communication channel on the existing air interface for communicating data associated with the new communication session. According to one embodiment, MAC layer messages may be employed between the MN 216 and a base station to terminate the existing communication channel and set up a new communication channel.

Further, alternatively, the first network device may terminate the existing communication channel on the existing air interface connection and, then, may set up a new communication channel may be set up via another air interface connection.

The method 300 has been described in reference to network devices illustrated in FIG. 2. However, it should be understood that more, fewer, different or equivalent network devices could also be used to execute the method described in reference to FIG. 3.

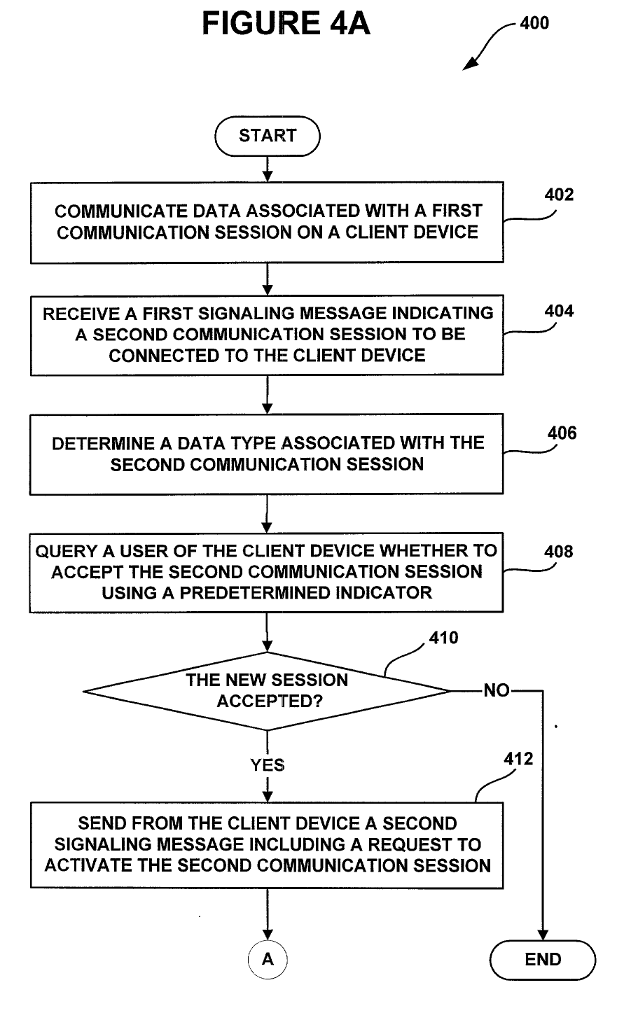

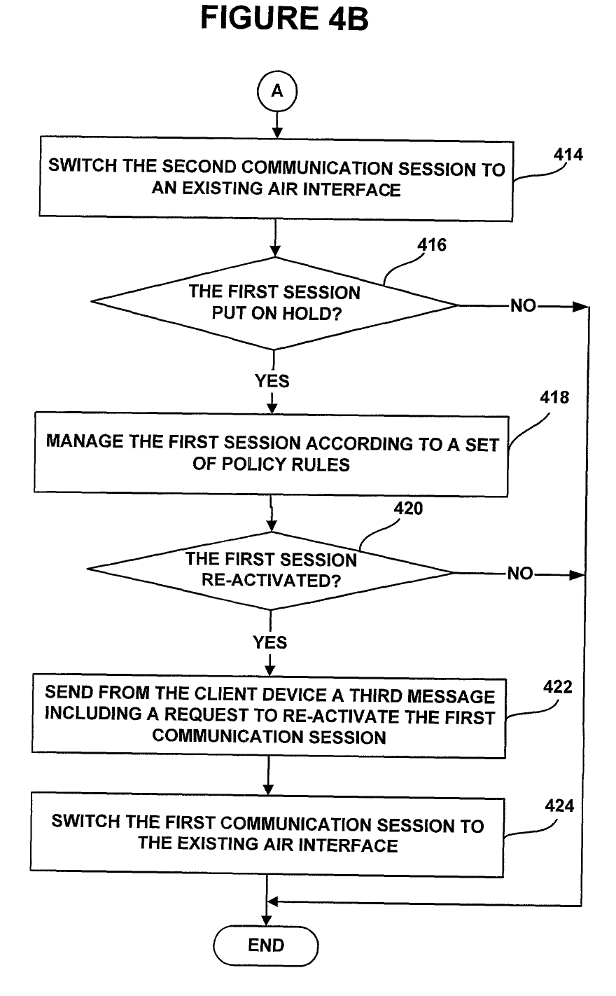

FIGS. 4A and 4B are a flow chart illustrating a method 400 for conducting a plurality of communication sessions at a mobile device. Referring to FIG. 4A, at step 402, a client device communicates data associated with a first communication session. In one embodiment illustrated in FIG. 2, the client device may include the MN 218 that communicates the data associated with the first communication session via the communication link 214.

At step 404, the client device receives a first signaling message indicating a new incoming communication session (a second communication session) to be established from a remote client device to the client device. According to an exemplary embodiment, a first network device such as the session signaling node 202 sends to the PDSN 216 a SIP INVITE message including a request to connect the second communication session to the client device. The PDSN 216 may then forward the SIP INVITE message to the client device.

When the client device receives the first signaling message, at step 406, the client device determines a type of data associated with the second communication session. In one embodiment, the first signaling message may include information regarding the type of data associated with the second communication session. For example, the first signaling message may indicate that the second communication session is associated with multimedia data or a VoIP call, for instance.

At step 408, the client device queries a user of the client device whether to accept the second communication session. To do that, the client device uses a predetermined indicator selected on the client device based on the data type associated with the second communication session. For example, the client device may be configured with a number of user-configurable indicators for notifying the user about data types associated with incoming communication sessions. In one embodiment, the indicators may include audible indicators, text indicators, or a combination thereof. However, it should be understood that different indicators could also be used.

At step 410, the client device determines if the user has accepted the second communication session. In one embodiment, the client device may include a user interface that is configured to enable the user to put an active communication session on hold and to switch to an incoming accepted communication session. The user may further use the interface to switch between the sessions. The user interface may be further configured to enable the user to terminate an active communication session and further to switch to an incoming communication session. According to an exemplary embodiment, the client device may use signaling messages, such as SIP signaling messages, to communicate the user's decisions regarding the sessions to a serving node such as a packet data serving node (PDSN 216). If the user does not accept the second communication session, the method 400 terminates, and the first communication session continues.

If the user accepts the second communication session, at step 412, the client device sends a second signaling message including a request to activate the second communication session. In one embodiment, if the user decides to put the first communication session on hold, the second signaling message includes a request to put the first communication session on hold. Alternatively, if the user decides to terminate the first communication session, the second signaling message includes a request to terminate the first communication session.

In one exemplary embodiment, the client device sends the second signaling message to a session signaling node such as a SIP proxy server that may communicate the received information to the serving node via one or more policy control messages. If the first communication session is put on hold, a policy control message may include instructions for the serving node to drop any packets associated with the first communication session and communicate packets associated with the second communication session. In an alternative embodiment, the serving node may include a set of policy rules including instructions on how to manage data associated with communication sessions that are suspended (put on hold). In one embodiment, the policy rules may be based on priority levels of different data types associated with the communication sessions. For example, based on the policy rules, the serving node may buffer data associated with the first communication session. Alternatively, the serving node may drop the data associated with the first communication session upon reaching a predetermined buffering threshold, for example. Different embodiments are possible as well. For example, each subscriber may have its own set of policy rules.

Referring to FIG. 4B, at step 414, when the serving node receives a policy control message including information regarding the acceptance of the second communication session on the client device, the serving node switches the second communication session to an existing air interface. In one embodiment, the air interface may include a plurality of communication channels. In such an embodiment, the serving node may switch the second communication channel to a communication channel that was employed for communicating data associated with the first communication session. In an alternative embodiment, the serving node may terminate a communication channel that was used for the first communication session and set up a new channel over the existing air interface connection to communicate data associated with the second communication session.

At step 416, the serving node determines whether the user of the client device put the first communication session on hold. The serving node may make that determination using the information in the policy control message received from the session signaling node. If the user requested a termination of the first communication session, the serving node may drop all packets associated with the first communication session, and the method 400 terminates. At step 418, if the first session is put on hold, the serving node manages the first session according to policy rules. As described in the preceding paragraphs, based on the policy rules, the serving node may drop all data associated with the first session. In an alternative embodiment, the policy rules may include instructions to terminate any session that is not reactivated in a predetermined time period. Many alternative embodiments are possible as well.

If the first communication session was put on hold, at step 420, the client device determines whether the first session is re-activated. According to an exemplary embodiment, the user of the client device may re-activate the first communication session using the user interface on the client device. At the same time, the user may either request termination of the second communication session or may put the second communication session on hold. Further, as mentioned in the preceding paragraph, the serving node may automatically terminate the first session based on the policy rules.

When the user requests re-activation of the first session, at step 422, the client device may generate and send to the session signaling node a third signaling message including a request to re-activate the first communication session. Further, the third signaling message may include information regarding the second communication session such as a termination request or a request to put the second communication on hold. The session signaling node may then generate and send to the serving node a policy control message including data received from the client device.

At step 424, when the serving node receives the policy control message including a request to re-activate the first communication session, the serving node switches the first communication session to the existing air interface. As mentioned in reference to switching the second communication session to the existing air interface, the first communication session may be switched to the same communication channel that was employed for the second communication session. Alternatively, the communication channel employed for the second communication channel may be terminated, and a new communication channel may be set up on the existing air interface.

According to one embodiment illustrated in FIG. 2, the client device of the method 400 is the mobile node 218, the serving node is the packet data serving node 216, and the session signaling node is the session signaling node 202. However, it should be understood that the exemplary method 400 is not limited to these network devices, and fewer, more, different, or equivalent devices could also be used.

It should be understood that the programs, processes, methods and systems described herein are not related or limited to any particular type of computer or network system (hardware or software), unless indicated otherwise. Various types of general purpose or specialized computer systems supporting the IP networking may be used with or perform operations in accordance with the teachings described herein.

In view of the wide variety of embodiments to which the principles of the present invention can be applied, it should be understood that the illustrated embodiments are examples only, and should not be taken as limiting the scope of the present invention. For example, the steps of the flow diagrams may be taken in sequences other than those described, more or fewer steps may be used, and more or fewer elements may be used in the block diagrams. While various elements of the preferred embodiments have been described as being implemented in software, in other embodiments in hardware or firmware implementations may alternatively be used, and vice-versa.

Further, it will be apparent to those of ordinary skill in the art that methods involved in the system for packet session control may be embodied in a computer program product that includes a computer readable medium. For example, a computer readable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

The claims should not be read as limited to the described order or elements unless stated to that effect. Therefore, all embodiments that come within the scope and spirit of the following claims and equivalents thereto are claimed as the invention.

What is claimed:

1. A method for controlling a plurality of communication sessions in a wireless communication system, the method comprising:
establishing a first communication session at a client device;
detecting a second communication session to be connected to the client device;
determining whether the second communication session is accepted on the client device;
determining whether the first communication session is put on hold on the client device to communicate data associated with the second communication session; if so,
intercepting data flow associated with the first communication session; and
switching data flow associated with the second communication session to an existing air interface associated with the first communication session.

2. A computer readable medium having stored therein instructions to execute the method of claim 1.

3. The method of claim 1, wherein the data flow comprises a multimedia data flow.

4. The method of claim 1, wherein the step of intercepting data flow associated with the first communication session comprises intercepting at a serving node the data flow associated with the first communication session.

5. The method of claim 4, wherein the serving node comprises a packet data serving node (PDSN) or a gateway general packet radio service support node (GGSN).

6. The method of claim 1, wherein the existing air interface comprises a plurality of communication channels and switching data flow associated with the second communication session to an existing air interface comprises using an existing communication channel associated with the first communication session for the data flow associated with the second communication session.

7. The method of claim 1, wherein the existing air interface comprises a plurality of communication channels and switching data flow associated with the second communication session to an existing air interface comprises:
terminating a first communication channel associated with the first communication session;
using a second communication channel on the existing air interface for the data flow associated with the second communication session.

8. A method for controlling a plurality of communication sessions on a mobile terminal in a communication system, the method comprising:
establishing a first communication session at the mobile terminal;
sending a signaling message to the mobile terminal indicating a second communication session to be connected to the mobile terminal;
determining whether the second communication session is accepted and the first communication session is put on hold on the mobile terminal; and, if so,
sending a policy management control message to a serving node associated with the mobile node, the policy management control message including instructions to intercept on the serving node a data flow associated with the first communication session, and further to use an existing air interface associated with the first communication session for communicating data associated with the second communication session.

9. A computer readable medium having stored therein instructions to execute the method of claim 8.

10. The method of claim 8, further comprising:
intercepting data flow associated with the first communication session at the serving node; and
switching data flow associated with the second communication session to the existing air interface between the serving node and the mobile node.

11. The method of claim 10, wherein the air interface comprises a plurality of channels, and switching data flow associated with the second communication session comprises using an existing communication channel associated with the first communication session for communicating the data flow associated with the second communication session.

12. The method of claim 10, wherein the air interface comprises a plurality of communication channels and switching data flow associated with the second communication session comprises:
terminating an existing communication channel associated with the first communication session; and
setting up a new communication channel for the data flow associated with the second communication session.

13. A method for controlling a plurality of communication sessions on a mobile node, the method comprising:
communicating data associated with a first communication session on the mobile node;
receiving a first signaling message on the mobile node, the first signaling message indicating a second communication session to be connected to the mobile node;
notifying a user of the mobile node about the second communication session, wherein the user is notified using an identifier selected on the mobile node based on a data type associated with the second communication session;
determining if the second communication session is accepted by the user; if so,
sending a second signaling message from the mobile node, the second signaling message comprising instructions to put the first communication session on hold and activate the second communication session;
intercepting a first data flow associated with the first communication session to the mobile node; and
switching a second data flow associated with the second communication session to an air interface associated with the first communication session.

14. A computer readable medium having stored therein instructions to execute the method of claim 13.

15. The method of claim 13, wherein the second signaling message is sent from the mobile node to a signaling node, the method further comprising:
sending a policy control message from the signaling node to a serving node associated with the mobile node, wherein the policy control message includes instructions to intercept the first data flow and further to activate the second data flow on the air interface.

16. The method of claim 13, wherein the air interface comprises a plurality of communication channels and switching the second data flow associated with the second communication session comprises:
terminating a first communication channel associated with the first communication session; and
using a second communication channel on the air interface to communicate data associated with the second communication session.

17. The method of claim 13, wherein the signaling node comprises a session initiation protocol (SIP) proxy server, and the serving node comprises a packet data serving node (PDSN) or a gateway general packet radio service support node (GGSN).

18. A network device for packet session control in a communication network, the network device configured to switch a second communication session associated with a mobile node to an existing air interface responsive to detecting that a first communication session associated with the mobile node is suspended.

19. The network device of claim 18, wherein the air interface comprises a plurality of communication channels, and the network device is configured to terminate data communication associated with the first communication session to the mobile node and further to switch the second communication session to a communication channel associated with the first communication session.

20. The network device of claim 18, wherein the air interface comprises a plurality of communication channels, and the network device is configured to terminate a first communication channels associated with the first communication session and set up a second communication channel over the existing air interface for data communication associated with the second communication session.

21. The network device of claim 18, wherein the network device comprises a packet data serving node (PDSN) or a gateway general packet radio service support node (GGSN).

22. A system for packet session control comprising in combination:
a mobile node comprising a user-configurable interface, the interface comprising a plurality of new session notification signals for a plurality of data types associated with incoming communication sessions, the mobile node being further configured to conduct a first communication session and receive a signaling message including instructions to connect a second communication session to the mobile node, and responsive to receiving the signaling message, the mobile node being further configured to determine a data type associated with the second communication session and provide a notification signal associated with the determined data type to a user associated with the mobile node;
a serving node in communication with the mobile node, the serving node configured to control communication session on the mobile node, the serving node being further configured to switch the second communication session to an existing air interface associated with the first communication session responsive to detecting that the first communication session is suspended on the mobile node and the second communication session is accepted by the user of the mobile node.

23. The system of claim 22, wherein the serving node comprises a packet data serving node (PDSN) or a gateway general packet radio service support node (GGSN), and the mobile node comprises a mobile router or a mobile client device.

24. The system of claim 22, wherein the air interface comprises a plurality of communication channels, and the serving node is configured to terminate a first communication channel associated with the first communication session and set up a second communication channel over the existing air interface.

25. The system of claim 24, wherein the serving node is further configured to terminate communication of data associated with the first communication session.

26. The system of claim 22, wherein the air interface comprises a plurality of communication channels and the first communication session is associated with a first communication channel over the air interface, and the serving node is configured to terminate data communication associated with the first communication session and further to switch data communication associated with second communication session to the first communication channel.
